(19) United States
(12) Patent Application Publication
(10) Pub. No.: US 2026/0091939 A1
(43) Pub. Date: Apr. 2, 2026

(54) Method for Four-Way Shuttle Storage Allocation and Interface Definition

(71) Applicant: Bullseye Intelligent Logistics Equipment (Suzhou) Co.,Ltd., Suzhou (CN)

(72) Inventors: Youcai Shen, Suzhou (CN); Jian Shen, Suzhou (CN); Libin Kuai, Suzhou (CN); Xiangming Wang, Suzhou (CN); Linhua Chen, Suzhou (CN)

(21) Appl. No.: 19/201,741

(22) Filed: May 7, 2025

(30) Foreign Application Priority Data
Sep. 29, 2024 (CN) 202411366192.8

(51) Int. Cl. B65G 1/137; G06Q 10/047; G06Q 10/0631; G06Q 10/0639; G06Q 10/087; G06Q 30/0201

(52) U.S. Cl. CPC B65G 1/1373; G06Q 10/047; G06Q 10/06316; G06Q 10/0639; G06Q 10/087; G06Q 30/0206

(57) ABSTRACT

A method for four-way shuttle storage allocation and interface definition. The decomposition of tasks and the generation of subtasks are recorded in the database, and the execution state of tasks, such as execution start and execution completion, are recorded in the database. When a device failure or system power outage occurs during operation, the unfinished tasks are continued after recovery without affecting the entire process. The method is applicable to any tasks assigned to the storage location, including the warehouse moving task, the cargo tallying task and the warehouse returning task. A first subtask assigned to the cargo location roadway entrance is created, and a second subtask to the cargo location is created after the completion of the first subtask. The method reduces the traffic jam when allocating cargo space for four-way dense storage, and improved the efficiency of storage and retrieval.

### FIELD OF THE INVENTION

The present invention relates generally to the field of automated warehousing and logistics technology, and more specifically, to a method for four-way shuttle storage allocation and interface definition.

### DESCRIPTION OF THE RELATED ART

In a high-density, multi-level warehouse with four-way shuttles, traditional storage and retrieval tasks, as well as relocation tasks, are typically generated as a single task from the starting point to the destination storage location and then issued to the execution system. This approach is relatively simple and commonly used in task generation and processing at the business level.

However, when multiple storage tasks are assigned to the same aisle, if a four-way shuttle carrying a pallet to an outer storage location reaches its destination first, the completed storage task may block subsequent incoming pallets from reaching inner storage locations. This results in task congestion and deadlock issues.

Even if a scheduling system enforces logical control to prioritize inner storage tasks before executing outer storage tasks, while this method can prevent task deadlocks, it negatively impacts storage and retrieval efficiency. This type of task control significantly reduces efficiency, especially in scenarios with high storage and retrieval demands, where maintaining operational efficiency is critical.

### BRIEF SUMMARY OF THE INVENTION

In light of the aforementioned disadvantages of existing technologies, the present invention provides a method for four-way shuttle storage allocation and interface definition.

This invention presents a method for storage location allocation and interface definition in a four-way shuttle-based warehouse system. It involves breaking down the main task of inbound goods storage into two subtasks: one for moving goods from the starting point to the aisle entrance, and another for moving goods from the aisle entrance to the storage location. The tasks are sequentially executed and managed by a warehouse management system and a scheduling system.

The system dynamically generates sub-tasks based on the current status of the storage aisles to avoid congestion, optimizing the flow of goods and equipment. It also incorporates task scheduling strategies, real-time monitoring, and database management to ensure smooth and efficient operations.

A primary object of the invention is the use of a warehouse management system to break down and manage inbound storage tasks into sub-tasks, ensuring efficient task execution and allocation based on real-time conditions.

Another object of the invention is the task scheduling system that coordinates and prioritizes the execution of sub-tasks to avoid aisle congestion and optimize the use of available equipment and storage locations.

Another object of the invention is to improve the task allocation process by considering factors such as equipment type, cargo characteristics, aisle structure, and task priority to optimize the execution of sub-tasks and storage location assignments.

Another object of the invention is the real-time monitoring of task execution, including tracking equipment status, cargo status, and task progress, to ensure timely completion and efficient operation within the warehouse system.

Another object of the invention is to ensure that, in cases of equipment failure or other disruptions, the system can quickly adapt and reassign tasks, allowing for uninterrupted task execution once the issue is resolved.

Another object of the invention is the incorporation of dynamic task generation based on aisle occupancy, preventing conflicts or delays when multiple tasks are allocated to the same aisle, thus improving overall warehouse throughput.

Another object of the invention is to introduce a novel task type that includes both the initial inbound task to the aisle entrance and the subsequent task from the aisle entrance to the storage location, optimizing the handling of goods within warehouse aisles.

Another object of the invention is to maintain task integrity and prevent data loss by recording the status of each task and sub-task in a database, allowing for system recovery in case of failure or disruption, and ensuring continuity in the execution of tasks.

In this respect, before explaining at least one embodiment of the invention in detail, it is to be understood that the invention is not limited in its application to the details of construction and to the arrangements of the components set forth in the following description or illustrated in drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a schematic diagram of the warehouse racks and aisles of the present invention.

FIG. 2 is an interaction diagram illustrating the communication between the warehouse management system and the warehouse scheduling system in the present invention.

FIG. 3 is a schematic diagram of the functional modules of the warehouse management system in the present invention.

FIG. 4 is a schematic diagram of the functional modules of the warehouse scheduling system in the present invention.

FIG. 5 is a flowchart of the inbound storage process in the present invention.

FIG. 6 is a schematic diagram illustrating the advantages of the allocation method in the present invention.

### DETAILED DESCRIPTION OF THE INVENTION

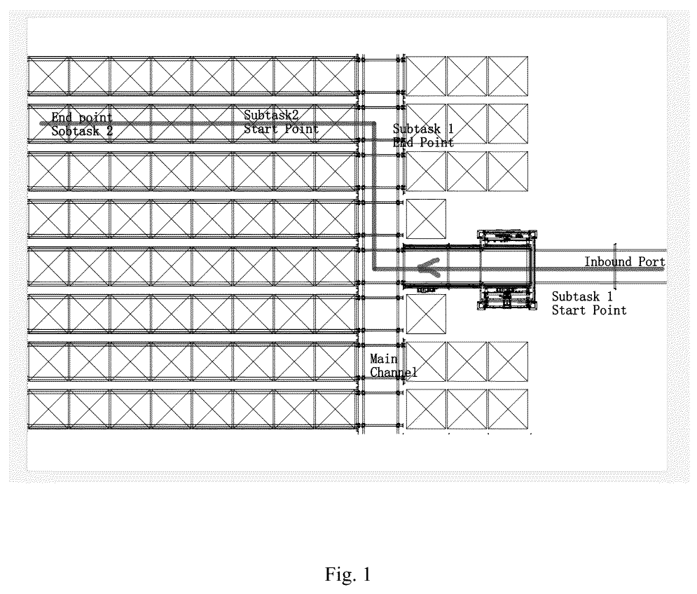

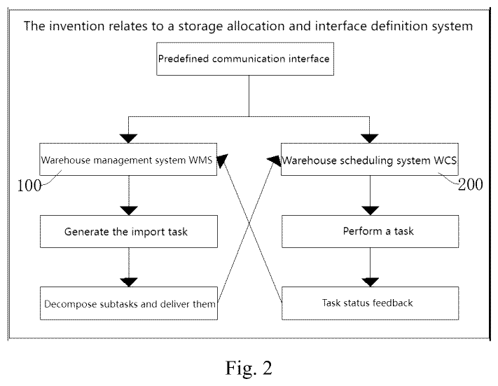

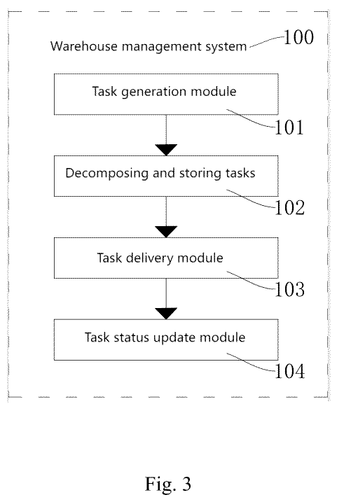

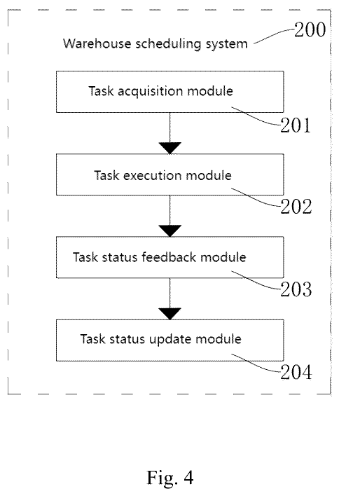

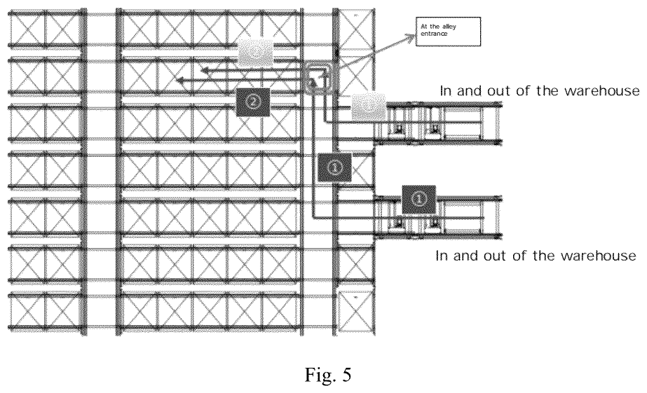

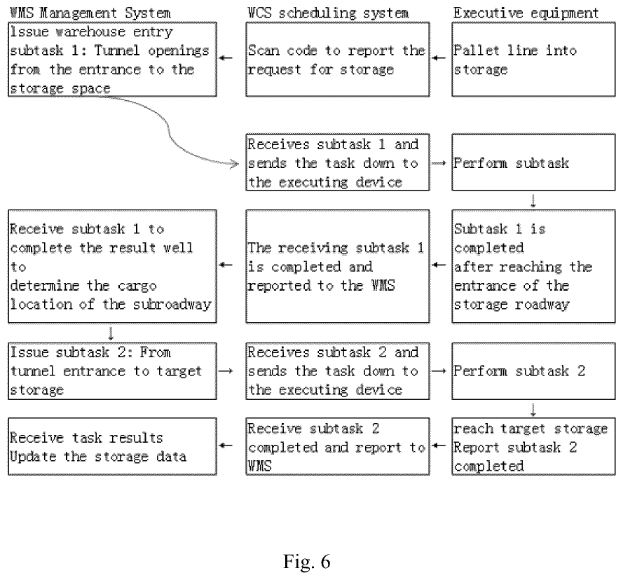

Turning now descriptively to the drawings, in which similar reference characters denote similar elements throughout the several views, FIG. 1 to FIG. 6 illustrate an embodiment of a method for four-way shuttle storage allocation and interface definition, which includes:
S1: A warehouse management system decomposes a main task of storage allocation into two subtasks: a first subtask, transporting an item from a starting point to an aisle entrance of a storage location, and a second subtask, transporting the item from the aisle entrance to a designated storage position; the warehouse management system then sequentially associated the two subtasks with the main task and is stored in a database;
S2: When the management system executes the main task, issues the first subtask based on associated subtasks in the main task; after the first subtask is completed, the warehouse management system evaluates occupancy status of the storage location within the aisle, generates the second subtask accordingly, and records it in the database;
S3: A warehousing scheduling system, upon receiving the first subtask assigned by the warehouse management system, dispatches handling equipment to execute the first subtask and reports execution status to the warehouse management system;
S4: The warehouse management system, upon receiving the execution status of the first subtask from the warehousing scheduling system, determines that the item has reached aisle entrance of the storage location and marks the first subtask as complete in the database; it then evaluates occupancy status of the storage location, generates a second subtask to transport the item from the aisle entrance to the storage location, and issues the second subtask to the warehouse scheduling system;
S5: The warehouse scheduling system, upon receiving the second subtask from the warehouse management system, dispatches handling equipment to execute the second task and reports execution status to the warehouse management system;
S6: The warehouse management system, upon receiving the execution status of the second subtask, updates the database to reflect the execution status of the second subtask and completion status of the main task.

In another embodiment, the first subtask and the second subtask are sequential tasks, the first subtask must be executed before the second subtask.

In another embodiment, during the execution of the first subtask, the execution of another subtask may change the occupancy status of the storage location within the aisle, and the generation of the second subtask is based on logical conditions determined after the completion of the first subtask.

In another embodiment, the second subtask is generated based on the occupancy status of the storage location. Therefore, there will be no blockage within the aisle, and no avoidance issues when multiple tasks enter the same aisle simultaneously. The first-executed task will be given priority in allocating storage locations within the aisle.

In another embodiment, when decomposing a task in S1, types of equipment, characteristics of item, structure of the aisle, and task priority must be considered:

Type of equipment: different types of handling equipment (such as four-way shuttle and stacker cranes) have varying handling capacities and efficiencies. The appropriate equipment should be selected to execute subtasks based on actual conditions.

Characteristics of item: different types of items (such as weight, volume, and shape) have different requirements for handling equipment and storage locations. characteristics should be considered when decomposing tasks and allocating storage locations.

Structure of the aisle: the structural features of different aisles, such as length, width, and turning radius, vary. Path planning and task scheduling should be conducted based on aisle structure.

Task priority: the priority of tasks should be set according to factors such as urgency and importance, ensuring that higher-priority tasks are executed first.

In another embodiment, in S2, strategies in scheduling tasks include:
Task sequencing: sort first subtasks based on task priority and aisle occupancy status, ensuring that higher-priority tasks or tasks in unoccupied aisles are issued first;
Path planning: determine optimal path for task execution based on aisle structure, equipment type and characteristics of item;
Load balancing: distribute tasks among different handling equipment to prevent overloading and to maintain overall operational efficiency.

In another embodiment, in S3, if handling equipment malfunctions during the execution of the first subtask, timely repair or replacement of the equipment is required and the task is rescheduled; if the item is damaged or lost, take prompt action and update the item information in the database; if the aisle is blocked, take immediate measures such as clearing obstacles or adjusting task path.

In another embodiment, in S4, during the generation and issuance of the second subtask, if certain storage locations within the aisle are occupied, a new available storage location is selected for the second subtask; if execution time of the first subtask changes, adjust issuance time of the second subtask; if the status of the handling equipment changes, adjust the equipment assigned to execute the second subtask.

In another embodiment, in S5, during the execution of the second subtask, the execution status is monitored in real-time, including its start, in-progress, and completion stages; the status of the handling equipment is monitored in real-time, including its operational and fault statuses; and the status of the item is monitored in real-time, including whether it has reached the target storage location and whether it has been damaged.

In another embodiment, in S6, after completion of the main task, following analyses are required:
Efficiency analysis: analyze completion time of the tasks and utilization rates of handling equipment to evaluate warehousing efficiency;
Cost analysis: analyze transportation costs and equipment maintenance costs of the tasks to evaluate costs;
Optimization analysis: based on data analysis results, optimize task decomposition, path planning, and equipment scheduling to improve efficiency and reduce costs.

When multiple tasks are assigned to storage locations within the same aisle in a warehouse system, there will inevitably be an order in which tasks arrive at the aisle entrance. Since the second subtask is generated based on the real-time storage occupancy in the aisle, there will be no congestion within the aisle. There is no need to worry about multiple inbound tasks requiring conflict resolution within the same aisle, as the task that arrives first is given priority in storage allocation.

In conventional task dispatch interfaces, the primary task types include inbound storage, outbound storage, relocation, and transportation. With the introduction of this storage allocation method, additional task types are included: inbound to the aisle entrance, placement from the aisle entrance to the storage location, and relocation to the aisle entrance.

The conventional inbound task is now redefined as a combination of two new subtasks: inbound to the aisle entrance and placement from the aisle entrance to the storage location. In this approach, the system first assigns the inbound sub-aisle, dispatching the first subtask to the sub-aisle entrance. Once the subtask reaches the sub-aisle entrance, the specific storage location is then assigned through a second subtask. This delayed allocation of the final storage location helps mitigate efficiency losses caused by strict sequence control of inbound tasks within the same aisle.

This invention decomposes the main inbound storage task into two serial subtasks: a first subtask, which is inbound to the aisle entrance, and a second subtask, which is the placement from the aisle entrance to the storage location. The second subtask can only be generated and executed after the first subtask has been issued and completed.

In traditional warehouse systems, storage allocation is typically determined at the inbound entrance. When multiple inbound and outbound tasks occur simultaneously, their arrival order can often cause path congestion or waiting delays, reducing operational efficiency. In contrast, this invention dynamically generates the second subtask only after the first subtask is completed, based on the real-time storage occupancy in the aisle. Once the second subtask is generated, it is immediately dispatched to the scheduling system, effectively preventing traffic congestion and efficiency losses.

As an optimized software system implementation, task decomposition and subtask generation are recorded in a database, along with execution statuses such as task initiation and completion. This ensures that if equipment failures or power outages occur during execution, the system can resume and continue any incomplete tasks upon recovery, maintaining seamless workflow operations.

This storage allocation method is applicable to any task type that involves assigning goods to a storage location, including relocation tasks, sorting tasks, and return-to-storage tasks. As long as the target position requires placing items into a designated storage location, this method can be applied. The first subtask is generated to allocate goods to the aisle entrance. Once the first subtask is completed, the second subtask is then generated to move the items to the final storage location.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention, which is intended to be defined by the following claims (and their equivalents) in which all terms are meant in their broadest reasonable sense unless otherwise indicated. Any headings utilized within the description are for convenience only and have no legal or limiting effect.

1. A method for four-way shuttle storage allocation and interface definition, comprising:
S1: A warehouse management system decomposes a main task of storage allocation into two subtasks: a first subtask, transporting an item from a starting point to an aisle entrance of a storage location, and a second subtask, transporting the item from the aisle entrance to a designated storage position; the warehouse management system then sequentially associated the two subtasks with the main task and is stored in a database;
S2: When the management system executes the main task, issues the first subtask based on associated subtasks in the main task; after the first subtask is completed, the warehouse management system evaluates occupancy status of the storage location within the aisle, generates the second subtask accordingly, and records it in the database;
S3: A warehousing scheduling system, upon receiving the first subtask assigned by the warehouse management system, dispatches handling equipment to execute the first subtask and reports execution status to the warehouse management system;
S4: The warehouse management system, upon receiving the execution status of the first subtask from the warehousing scheduling system, determines that the item has reached aisle entrance of the storage location and marks the first subtask as complete in the database; it then evaluates occupancy status of the storage location, generates a second subtask to transport the item from the aisle entrance to the storage location, and issues the second subtask to the warehouse scheduling system;
S5: The warehouse scheduling system, upon receiving the second subtask from the warehouse management system, dispatches handling equipment to execute the second task and reports execution status to the warehouse management system;
S6: The warehouse management system, upon receiving the execution status of the second subtask, updates the database to reflect the execution status of the second subtask and completion status of the main task.

2. The method for four-way shuttle storage allocation and interface definition in claim 1, wherein the first subtask and the second subtask are sequential tasks, the first subtask must be executed before the second subtask.

3. The method for four-way shuttle storage allocation and interface definition in claim 2, wherein during the execution of the first subtask, the execution of another subtask may change the occupancy status of the storage location within the aisle, and the generation of the second subtask is based on logical conditions determined after the completion of the first subtask.

4. The method for four-way shuttle storage allocation and interface definition in claim 3, wherein the second subtask is generated based on the occupancy status of the storage location.

5. The method for four-way shuttle storage allocation and interface definition in claim 1, wherein types of equipment, characteristics of item, structure of the aisle, and task priority must be considered when decomposing a task in S1.

6. The method for four-way shuttle storage allocation and interface definition in claim 1, wherein S2, strategies in scheduling tasks include:
Task sequencing: sort first subtasks based on task priority and aisle occupancy status, ensuring that higher-priority tasks or tasks in unoccupied aisles are issued first;
Path planning: determine optimal path for task execution based on aisle structure, equipment type and characteristics of item;
Load balancing: distribute tasks among different handling equipment to prevent overloading and to maintain overall operational efficiency.

7. The method for four-way shuttle storage allocation and interface definition in claim 1, wherein S3, if handling equipment malfunctions during the execution of the first subtask, timely repair or replacement of the equipment is required and the task is rescheduled; if the item is damaged or lost, take prompt action and update the item information in the database; if the aisle is blocked, take immediate measures such as clearing obstacles or adjusting task path.

8. The method for four-way shuttle storage allocation and interface definition in claim 1, wherein S4, during the generation and issuance of the second subtask, if certain storage locations within the aisle are occupied, a new available storage location is selected for the second subtask; if execution time of the first subtask changes, adjust issuance time of the second subtask; if the status of the handling equipment changes, adjust the equipment assigned to execute the second subtask.

9. The method for four-way shuttle storage allocation and interface definition in claim 1, wherein S5, during the execution of the second subtask, the execution status is monitored in real-time, including its start, in-progress, and completion stages; the status of the handling equipment is monitored in real-time, including its operational and fault statuses; and the status of the item is monitored in real-time, including whether it has reached the target storage location and whether it has been damaged.

10. The method for four-way shuttle storage allocation and interface definition in claim 1, wherein S6, after completion of the main task, following analyses are required:
Efficiency analysis: analyze completion time of the tasks and utilization rates of handling equipment to evaluate warehousing efficiency;
Cost analysis: analyze transportation costs and equipment maintenance costs of the tasks to evaluate costs;
Optimization analysis: based on data analysis results, optimize task decomposition, path planning, and equipment scheduling to improve efficiency and reduce costs.
